(19) United States
(12) Patent Application Publication
(10) Pub. No.: US 2025/0272218 A1
(43) Pub. Date: Aug. 28, 2025

(54) SYSTEMS AND METHODS FOR AUTOMATED EVALUATION AND IMPROVEMENT OF CODE QUALITY

(71) Applicant: JPMORGAN CHASE BANK, N.A., New York, NY (US)

(72) Inventors: Andre FRADE, London (GB); Marcus KAISER, London (GB); Amal VAIDYA, London (GB); Maxime LABONNE, London (GB); Sean MORAN, London (GB); Eric LIU, London (GB); Bismayan CHAKRABARTI, North Brunswick Township, NJ (US)

(21) Appl. No.: 19/061,306

(22) Filed: Feb. 24, 2025

Related U.S. Application Data
(60) Provisional application No. 63/558,833, filed on Feb. 28, 2024.

(51) Int. Cl. G06F 11/3604

(52) U.S. Cl. CPC G06F 11/3608

(57) ABSTRACT

Automated evaluation and improvement of code quality is disclosed. A method may include: receiving code to optimize; evaluating the code for a plurality of code quality dimensions using a LLM, wherein the LLM returns a code quality score and a qualitative summary for each code quality dimension; generating an overall code quality score based on the code quality score and the qualitative summary; improving the code using the LLM based on the code quality score and the qualitative summary for each code quality dimension; evaluating the improved code for the plurality of code quality dimensions using the wherein the LLM returns an updated code quality score and an updated qualitative summary; generating an overall code quality score based on the updated code quality score and the updated qualitative summary; and outputting the improved code in response to the updated code quality score being higher than the overall code quality score.

### RELATED APPLICATIONS

This application claims priority to, and the benefit of, U.S. Provisional Patent Application Ser. No. 63/558,833, filed Feb. 28, 2024, the disclosure of which is hereby incorporated, by reference, in its entirety.

### BACKGROUND OF THE INVENTION

### 1. Field of the Invention

Embodiments relate to systems and methods for automated evaluation and improvement of code quality.

### 2. Description of the Related Art

Software code, the backbone of modern digital systems, is a set of instructions that computers follow to perform specific tasks. It is ubiquitous, powering everything from our smartphones and laptops to complex production systems in industries such as finance, healthcare, and transportation. As code becomes increasingly integral to important business functions, the concept of code quality has emerged as a critical consideration.

Code quality refers to how well the code performs its intended function, how easily it can be understood and modified, and how resilient it is to potential errors or changes. High-quality code is not only efficient and reliable but also maintainable, readable, and scalable. It reduces the risk of software bugs, makes the code easier to understand and modify, and can lead to more stable and efficient systems. This is why it is crucial for code to be of good quality.

Assessing and improving code quality, however, is not a straightforward task. Common strategies include code reviews, where developers examine the code for potential issues and suggest improvements, and automated testing, where software tools are used to check the code against a set of predefined criteria. Metrics such as cyclomatic complexity, which measures the complexity of the code, and code coverage, which measures the percentage of code that is tested, are often used to evaluate quality. These strategies, however, have their limitations. Manual code reviews can be subjective, time-consuming, and require programming language specific expertise. Algorithmic assessments are narrow focused, inflexible, non-exhaustive, and programming language specific.

### SUMMARY OF THE INVENTION

Systems and methods for automated evaluation and improvement of code quality are disclosed. According to an embodiment, a method may include: (1) receiving, by a code optimization computer program executed by an electronic device, code to optimize; (2) evaluating, by the code optimization computer program, the code for a plurality of code quality dimensions using a large language model (LLM), wherein the LLM returns a code quality score and a qualitative summary for each code quality dimension; (3) generating, by the code optimization computer program, an overall code quality score based on the code quality score and the qualitative summary; (4) improving, by the code optimization computer program, the code using the LLM based on the code quality score and the qualitative summary for each code quality dimension; (5) evaluating, by the code optimization computer program, the improved code for the plurality of code quality dimensions using the wherein the LLM returns an updated code quality score and an updated qualitative summary; (6) generating, by the code optimization computer program, an overall code quality score based on the updated code quality score and the updated qualitative summary; and (7) outputting, by the code optimization computer program, the improved code in response to the updated code quality score being higher than the overall code quality score.

In one embodiment, the code quality dimensions comprise readability, maintainability, testability, efficiency, robustness, security, documentation, modularity, scalability, and/or portability.

In one embodiment, the code optimization computer program prompts the LLM with code quality dimension-related questions/statements.

In one embodiment, the LLM responds to the code quality dimension-related questions/statements with true, false, or not applicable or values representing the same.

In one embodiment, the LLM is provided with an equal number of quality dimension-related questions/statements for each code quality dimension.

In one embodiment, the overall code quality score for each code quality dimension is an average of the code quality score for each quality dimension-related question/statement from the LLM.

In one embodiment, the LLM returns improvement points, an explanation report, and the improved code in response to a prompt from the code optimization computer program to improve the code.

In one embodiment, the method may also include validating, by the code optimization computer program, that the improved code exhibits its original intended functionality and/or expected behavior.

In one embodiment, the steps of evaluating the improved code and generating the overall code quality score based on the updated code quality score and the updated qualitative summary are repeated for a number of iterations.

In one embodiment, the method may also include outputting, by the code optimization computer program, the code quality score, the qualitative summary, the updated code quality score, and the updated qualitative summary for each code quality dimension.

According to another embodiment, a non-transitory computer readable storage medium may include instructions stored thereon, which when read and executed by one or more computer processors, cause the one or more computer processors to perform steps comprising: receiving code to optimize; evaluating the code for a plurality of code quality dimensions using a large language model (LLM), wherein the LLM returns a code quality score and a qualitative summary for each code quality dimension; generating an overall code quality score based on the code quality score and the qualitative summary; improving the code using the LLM based on the code quality score and the qualitative summary for each code quality dimension; evaluating the improved code for the plurality of code quality dimensions using the wherein the LLM returns an updated code quality score and an updated qualitative summary; generating an overall code quality score based on the updated code quality score and the updated qualitative summary; and outputting the improved code in response to the updated code quality score being higher than the overall code quality score.

In one embodiment, the code quality dimensions comprise readability, maintainability, testability, efficiency, robustness, security, documentation, modularity, scalability, and/or portability.

In one embodiment, the LLM is prompted with code quality dimension-related questions/statements.

In one embodiment, the LLM responds to the code quality dimension-related questions/statements with true, false, or not applicable or values representing the same.

In one embodiment, the LLM is provided with an equal number of quality dimension-related questions/statements for each code quality dimension.

In one embodiment, the overall code quality score for each code quality dimension is an average of the code quality score for each quality dimension-related question/statement from the LLM.

In one embodiment, the LLM returns improvement points, an explanation report, and the improved code in response to a prompt to improve the code.

In one embodiment, the non-transitory computer readable storage medium may also include instructions stored thereon, which when read and executed by the one or more computer processors, cause the one or more computer processors to perform steps comprising: validating that the improved code exhibits its original intended functionality and/or expected behavior.

In one embodiment, the steps of evaluating the improved code and generating the overall code quality score based on the updated code quality score and the updated qualitative summary are repeated for a number of iterations.

In one embodiment, the non-transitory computer readable storage medium may also include instructions stored thereon, which when read and executed by the one or more computer processors, cause the one or more computer processors to perform steps comprising: outputting the code quality score, the qualitative summary, the updated code quality score, and the updated qualitative summary for each code quality dimension.

### BRIEF DESCRIPTION OF THE DRAWINGS

For a more complete understanding of the present invention, the objects and advantages thereof, reference is now made to the following descriptions taken in connection with the accompanying drawings in which:

FIG. 1 illustrates a system for code quality evaluation and improvement according to an embodiment;

FIG. 2 illustrates a method for code quality evaluation and improvement according to an embodiment;

FIG. 3 depicts an example of some input code script and the corresponding quality report, according to an embodiment;

FIG. 4 depicts an example of a comparison between some input code script and its initial quality assessment, versus an improved version of the final quality assessment report, according to an embodiment;

FIG. 5 depicts an exemplary computing system for implementing aspects of the present disclosure.

### DETAILED DESCRIPTION OF PREFERRED EMBODIMENTS

Systems and methods for automated evaluation and improvement of code quality are disclosed.

Large language models, or “LLMs,” have emerged as extensive knowledge bases capable of understanding and generating human-like text. These models have been trained on vast amounts of data, enabling them to provide insights on a wide range of topics. Much like human language, software code follows certain rules and patterns. Thus, the applicability of large language models has recently been extended to the realm of software code generation.

With their ability to understand context and generate coherent responses, LLMs can also be applied to code quality evaluation and improvement. Contrarily to existing solutions, LLMs analyze and re-factor the code in a similar fashion to human experts for a fraction of resources, considering not just the syntax, but also the semantics and the overall structure of the code to provide a holistic and nuanced evaluation and improvement of its quality.

Code quality is a subjective concept. Thus, to make it more objective, embodiments break code quality into a plurality of code quality dimensions. Example code quality dimensions may include:

Readability: Good code should be easy to read and understand. This includes using clear variable and function names, adding comments where necessary, and following a consistent coding style. Code may be checked for the following: variable and function names are descriptive and meaningful; the code consistently follows a single specific code style guide; there are comments that clearly explain complex or non-obvious; parts of the provided code, without assuming prior knowledge; the provided code is free of unexplained constants or magic numbers; each existing function is dedicated to a single task; etc.

Maintainability: Code should be easy to maintain. This means it should be organized in a way that makes it easy to add new features or fix bugs without breaking existing functionality. Code may be checked for the following: the provided code is organized in a logical and understandable manner, allowing for easy comprehension; the provided code strictly adheres to the DRY (Do not Repeat Yourself) principle, avoiding unnecessary repetition; the code features can be added or modified without affecting existing functionality; the provided code is effectively free of duplication, promoting efficiency and maintainability; there are clear interfaces between different parts of the provided code, facilitating seamless interaction; etc.

Testability: High-quality code is often designed in a way that makes it easy to test. This might involve writing unit tests, integration tests, and end-to-end tests. Code coverage is also an important metric to consider. Code may be checked for the following: the structure of the provided code facilitates easy mocking of dependencies; the provided code produces consistent and predictable outputs for specific inputs; the provided code is free of global states and variables; the provided code is free from deep nesting or complex control flow, that could complicate testing; the provided code is organized in a way that allows the straightforward measurement of code coverage; etc.

Efficiency: Code should be efficient and not waste system resources. This involves considering things like time complexity and space complexity and optimizing where necessary. Code may be checked for the following: the provided code makes efficient use of data structures; the provided code avoids creating unnecessary objects or data; the provided code avoids suboptimal computations, such as unnecessary loops or repeated operations that could be optimized; the provided code promotes the efficient use of system resources; the provided code addresses any existing bottlenecks that could slow down the code; etc.

Robustness: Good code should be able to handle unexpected situations gracefully. This may involve things like error handling and input validation. Code may be checked for the following: Does the provided code validate and sanitize inputs in all relevant scenarios? Does the provided code handle edge cases and unexpected inputs gracefully in all relevant scenarios? Are there appropriate error handling and exception handling mechanisms in place for all relevant scenarios? Does the provided code handle errors and exceptions gracefully in all relevant scenarios? Does the provided code account for any potential race conditions, concurrency issues, or deadlock situations in all relevant scenarios?

Security: Code should be written in a way that minimizes security risks. This may involve things like sanitizing user input, using prepared statements to prevent SQL injection, and following best practices for handling sensitive data. Code may be checked for the following: the provided code consistently sanitizes user inputs to prevent injection attacks; the provided code is completely free of hardcoded sensitive data, such as passwords and API keys; the provided code adheres to established best practices for secure coding; the provided code implements comprehensive error handling to prevent leakage of sensitive information; the provided code utilizes secure communication protocols when performing network operations; etc.

Documentation: Good code should be well-documented. This may include not only comments in the code itself, but also external documentation that explains how to use and modify the code. Code may be checked for the following: comments are provided to explain non-obvious parts of the code; there is a concise and clear description of the code's functionality; input parameters are documented; output values are documented; side effects are documented; etc.

Modularity: Code should be modular, meaning it is divided into small, independent parts that can be easily understood, modified, and tested in isolation. Code may be checked for the following: the provided code is divided into small, independent functions that perform specific tasks; individual parts of the provided code can be used, modified, and tested independently without affecting other parts; the provided code avoids deep nesting and complex control flow structures; the provided code adheres to the principles of high cohesion (related functionality within a single unit) and low coupling (minimal dependencies between units); different parts of the code are separated by well-defined interfaces to facilitate communication and maintainability; etc.

Scalability: The code should be designed in a way that it can handle increased load, whether that's more data, more users, or more transactions. Code may be checked for the following: the provided code is designed to handle increased data loads efficiently, or can it be easily adapted to do so; the provided code is designed to handle an increased number of users efficiently, or can it be easily adapted to do so; the provided code makes efficient use of resources, such as CPU and memory; the provided code is free of bottlenecks that could potentially limit scalability; the provided code is designed to work in a distributed environment efficiently, or can it be easily adapted to do so; etc.

Portability: The code should be able to run in different environments without requiring major changes. Code may be checked for the following: the provided code avoids relying on any platform-specific features or behavior; the provided code can run in different environments without requiring major changes; the provided code is free of hardcoded file paths or URLs that would limit portability; the provided code uses standard libraries and APIs as much as possible; all dependencies are clearly specified and easy to install; etc.

Additional, fewer, or different code quality dimensions may be used as is necessary and/or desired.

Embodiments may include a programming language agnostic LLM-based framework for the assessment and improvement of code quality across a plurality of code quality dimensions. The code evaluation capability may be used as a standalone tool and provides quality feedback in both, qualitative and quantitative format, to be leveraged by developers as clear and actionable insights or as input to automated quality control pipelines. The code improvement capability may leverage the code evaluation feedback for the automated and iterative improvement of code.

In embodiments, a prompt-enabled engineered code quality evaluation solution may include three components: a LLM, a prompt, and a block for output post processing. The LLM may include, for example, the GPT-4 large language model engine. The prompt may include a set of context and instructions designed to query the LLM against code in a focused and robust manner. For example, each code quality dimension may be addressed by a plurality of crafted questions/statements that may have three possible answers: true, false, or not applicable. These responses may be represented by the values 1, −1, and 0.

The questions/statements may be crafted to comprehensively cover the key aspects of their corresponding code quality dimension and may not overlap in code quality dimension scope probing. They may be general enough to be applicable to any code script and programming language, and may be formulated, such that having “True” as answer reflects a step towards the high-quality end of the code quality spectrum, having “False” as answer reflects a step towards the low-quality end of the code quality spectrum, and having “Not Applicable” as answer does not have an impact on the code quality spectrum.

In embodiment, the questions/statements may be provided in natural language.

The expected LLM output may include the numerical assessment of the code quality dimension-related questions/statements (i.e., quantitative feedback) and a short natural language overall summary of code quality from the code quality dimension perspective (i.e., a qualitative assessment).

LLMs are known to exhibit some stochasticity in their responses, even if its temperature parameter (that regulates the level of creativity in output generation) is set to zero. To account for inconsistencies and promote robust answers, a self-consistency type of framework is considered. Thus, a given query may be run a specified number of times allowing for the aggregation—hence noise smoothing—of the results. Output aggregation may occur in the post processing block.

The post processing block may transform the LLM's output into the final code quality feedback. For example, for each code quality dimension: (1) the qualitative feedback produced across runs may be summarized into a final qualitative assessment, using the LLM summary capabilities; and (2) the quantitative feedback may be computed as the sum of answers across the code quality dimension-related questions/statements.

An overall code quality score may be produced as the average of the code quality dimension-wise scores and an overall summary report is produced from the code quality dimension-wise summaries, using the LLM summary capabilities.

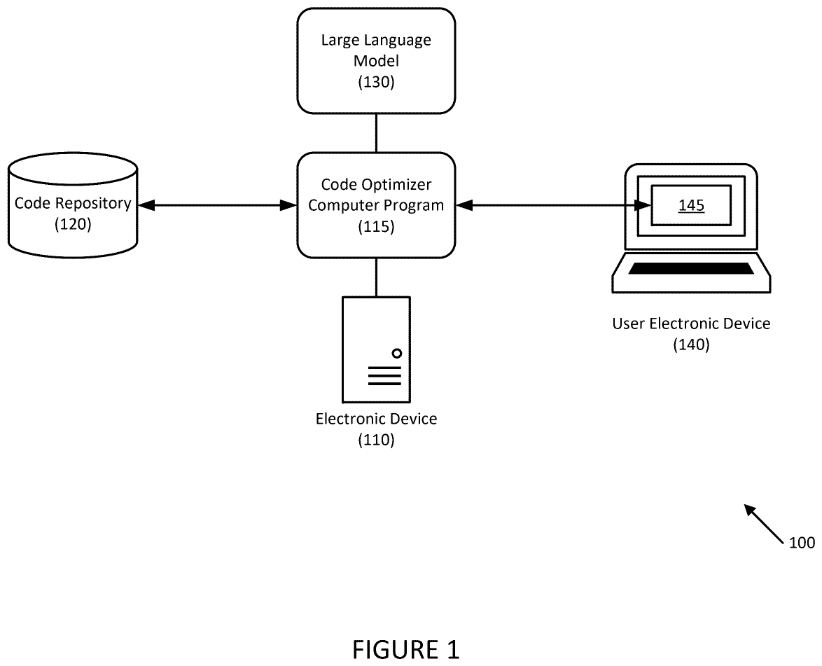

Referring to FIG. 1, a system for code quality evaluation and improvement is provided according to an embodiment. System 100 may include electronic device 110, which may be a server (e.g., physical and/or cloud-based), a computer (e.g., workstation, desktop, laptop, notebook, etc.), etc. Electronic device 110 may execute code optimizer computer program 115, which may receive code from code repository 120 or any alternative sources and may optimize the code.

Code repository 120 may store code to be optimized. For example, the code may include code snippets.

Code optimizer computer program 115 may provide insights and guidance for improving the code to large language model 130. LLM 130 may refer to GPT-4 large language model, or any other large language model with similar programming capabilities.

System 100 may further include user electronic device 140, such as a computer, a smart device (e.g., smart phone, smart watch, etc.), an Internet of Things (IoT) appliance, etc. User electronic device 140 may execute user computer program 145, which may identify code for optimization, and may return optimized code for a user to review. It may further present a final evaluation report for the code optimization to the user.

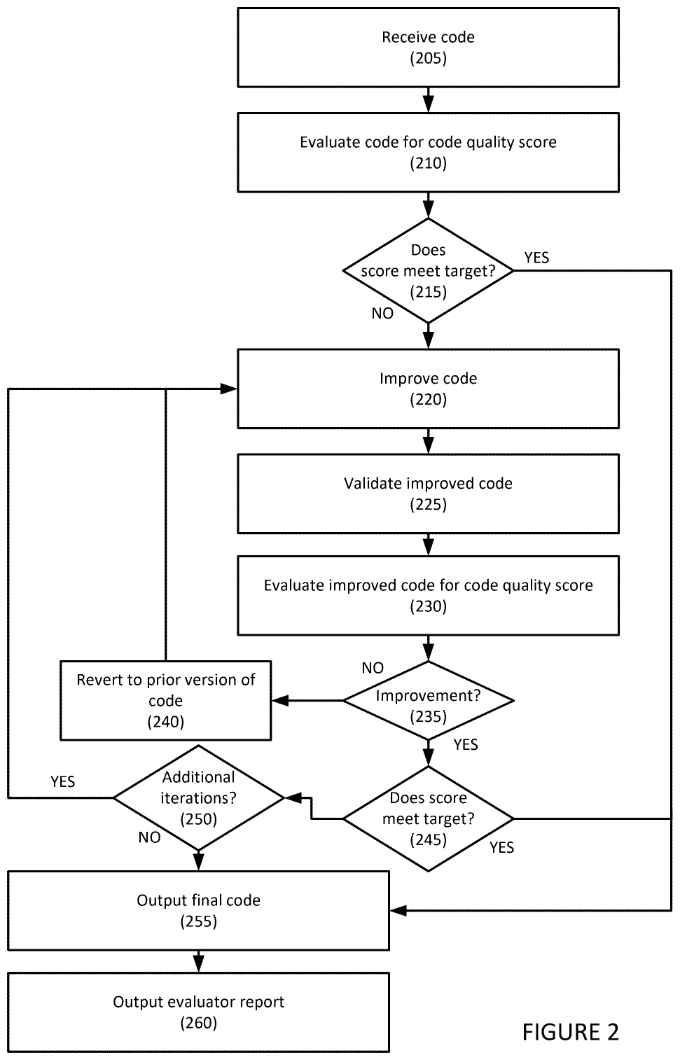

Referring to FIG. 2, a method for code quality evaluation and improvement is provided according to an embodiment.

In step 205, a computer program, such as a code optimizer computer program, may receive code to optimize from, for example, a code repository.

In step 210, the computer program may evaluate the code using, for example, an LLM. In one embodiment, the computer program may provide the code with one or more prompts (e.g., code quality dimension-related questions/statements) to the LLM.

For example, the LLM may be exposed to the code against which it evaluates each of the code quality dimension-wise statements with, for example, 1, −1, or 0, representing whether, given the code, the statement is true, false, or not applicable, as well as a short summary around each dimension. Scores and summaries may be produced. The final result may include a written summary, as well as scores per dimension, and the overall score of code quality.

The prompt may include a set of context and instructions designed to query the LLM against code in a focused and robust manner. For example, each dimension of code quality may be addressed by a plurality of crafted questions/statements that may have three possible answers: true, false, or not applicable. These responses may be represented by the values 1, −1, and 0. The LLM may further provide a short natural language overall summary of code quality from the dimension perspective.

The questions/statements may be crafted to comprehensively cover the key aspects of their corresponding code quality dimension and may not overlap in dimension scope probing to avoid over representation of any one particular aspect of the quality dimension. They may be general enough to be applicable to any code script and programming language, and may be formulated, such that having “True” as answer reflects a step towards the high-quality end of the code quality spectrum, having “False” as answer reflects a step towards the low-quality end of the code quality spectrum, and having “Not Applicable” as answer does not have an impact on the code quality spectrum.

In embodiment, the questions/statements may be provided in natural language.

In one embodiment, the computer program may use a prompt template that combines 1) the code to be evaluated; 2) the set of questions/statements for a given quality dimension; 3) the task to be performed, and 4) the desired output format. A possible example prompt template (with additional line breaks) for the LLM is provided below:
role:
“You are a helpful and harmless AI software engineer. You must provide an answer to the following request. Be brief and precise.”
prompt:
″″″
   ###CODE:
   ′′′
   {code}
   ′′′
   ###STATEMENTS:
   {dimension_statements}
   ###TASK:
   Think step by step to assess the veracity of each STATEMENT in light of the CODE provided.
   Your answer to each statement must come from one of the following:
      *−1 if the statement is false,
      *1 if the statement is true,
      *0 if the statement is not applicable or there is not enough evidence in the CODE to address it.
   You must also provide a short summary about the quality of the code from a {quality_dimension} perspective, justifying your answers across the various statements.
   ###OUTPUT:
   Return your answer in valid JSON as shown below:
   ′′′json=
   {{
      “insight”: <code quality summary: str>,
      “scores”: [<score_to_statement1:int>, <score_to_statement2:int>, . . . ]
   }}
″″″

For each question/statement, the LLM may return a numerical assessment of the code quality dimension-related questions/statements (i.e., quantitative feedback) and a short natural language overall summary of code quality from the dimension perspective (e.g., a qualitative summary).

The code quality score associated with each code quality dimension corresponds to the sum of values attributed to its corresponding statements. Thus, for the code quality dimensions to be equally represented, each code quality dimension should be associated to an equal number of statements.

The process may be repeated for each code quality dimension-related questions/statement, and the results may be aggregated.

The overall code quality score is then the average of code quality dimension-wise code quality scores, and the overall qualitative assessment is an aggregated summary of the dimension wise natural language summaries.

In step 215, the overall code quality score may be compared to a target code quality score. The overall code target quality score may be a configurable parameter of the code improvement strategy that may be set by the user. In one embodiment, the overall code target quality score may be bound based on the number of statements per dimension. For example, if there are five statements per dimension, the overall code target quality score may be bounded by a scale of −5 to 5.

If the overall code quality score meets the target code quality score, the process may continue to step 255. If the overall code quality score does not meet the target code score, in step 220, the code may be improved.

During code improvement, the code script and its corresponding overall qualitative summary may be provided to the LLM. For example, the qualitative summary may provide direction and instructions that a LLM may use for code improvement and the overall quantitative score may reflect the extent of code improvements achieved at each iteration, and it is used as a numerical dynamic baseline that ensures the unidirectional increase of quality of a given code script.

An example prompt is:
role:
“You are a helpful and harmless AI software engineer. You must provide an answer to the following request. Be brief and precise.”
prompt:
″″″
   ###Code:
   {code}
   ###Quality Dimensions Feedback:
   {quality_insight}
   ###TASK:
   You are provided with a code script and detailed feedback for each quality dimension.
   For each quality dimension, you are provided with:
      *A score from −5 to 5. The higher the score, the better the quality.
      *Dimension insights, highlighting potential areas of improvement.
   Think step by step to complete the following:
      1) For each dimension, reflect on the score and insights.
      2) Condense a list of improvement points, so that the code would be evaluated at a higher score for each dimension.
      3) Improve the code script according to the improvement points, prioritizing dimensions with lower scores.
      4) Return:
         *the improvement points identified
         *the improved version of the code script
         *explanations for each of the changes you've made
   Note:
   *ALL improvement points MUST be addressed via meaningful changes to the code.
   ###OUTPUT:
   Your final output contains two parts:
   Return your answer in a valid JSON as shown below:
   ′′′json
   {{
      “improvement_points”: List [str],
      “explanation_report”: List [str]
   }}
   Then quote your code in the following section
   ′′′improved_code
   {{improved_code_here}}
   ′′′
″″″

The prompt-based task may include pinpointing all the areas of improvement mentioned in the assessment feedback and modifying the code accordingly to address these points. The output consists of a new version of the code script.

In step 225, the computer program may validate the improved code. For example, the computer program may ensure that the improved code compiles/runs. Test cases built for the original code script may optionally be run against the updated version of the code to ensure that it still exhibits its original intended functionality and/or expected behavior. Such validation checks constitute a first step towards the meaningful evolution of the code.

Note that the failure of the validation may lead to the immediate restart of a new iteration as a new code improvement attempt, which considers the inputs of the previous failed cycle. The failed iteration may still count as an iteration.

In step 230, the computer program may evaluate the improved code. The improved code may be evaluated with the same criteria that was used to establish the initial assessment. This may be similar to step 210, above.

If, in step 235, the overall code quality score of the new code version drops relative to its previous version, no overall improvement was achieved. In this case, in step 240, the computer program may revert to the version of the code (i.e., prior to step 220) and may then return to step 220 for another code improvement attempt. The failed iteration may still count as an iteration.

Otherwise, if the overall code quality score of the new code increases relative to its last version, the iteration is deemed successful. The quality references may then be updated—the new overall code quality score becomes the new numerical baseline for improvement, and the updated qualitative summary is used as input to the first step of a new iteration.

In step 245, the computer program may determine if the updated overall code quality score meets the target code quality score. This may be similar to step 215, above. If the updated overall code quality score meets the target code quality score, the process may continue to step 255. If the updated overall code quality score does not meet the target code quality score, the process may continue to step 250, where the computer program may check whether there are additional iterations to execute.

If there are additional iterations, the process may return to step 220. The number of iterations may be a configurable parameter of the code improvement strategy that may be set by the user. The exercise terminates when the maximum number of iterations is met, or when a target overall quality score is reached.

If there are no additional iterations, the process may continue to step 255, where the computer program may output the improved code to the user, and/or may store the improved code in the code repository.

In step 260, the computer program may output reports on the code. For example, the code version, the code quality score, and the qualitative summary produced at each iteration may be accessible to a user. Such insights may help users understand the drivers of the code quality improvement evolution on a case basis, on a granular level.

In one embodiment, the final code reports and improved code may be output to the user.

The quantitative score may be presented to the user as a graph, and the qualitative summary may be provided as a text summary.

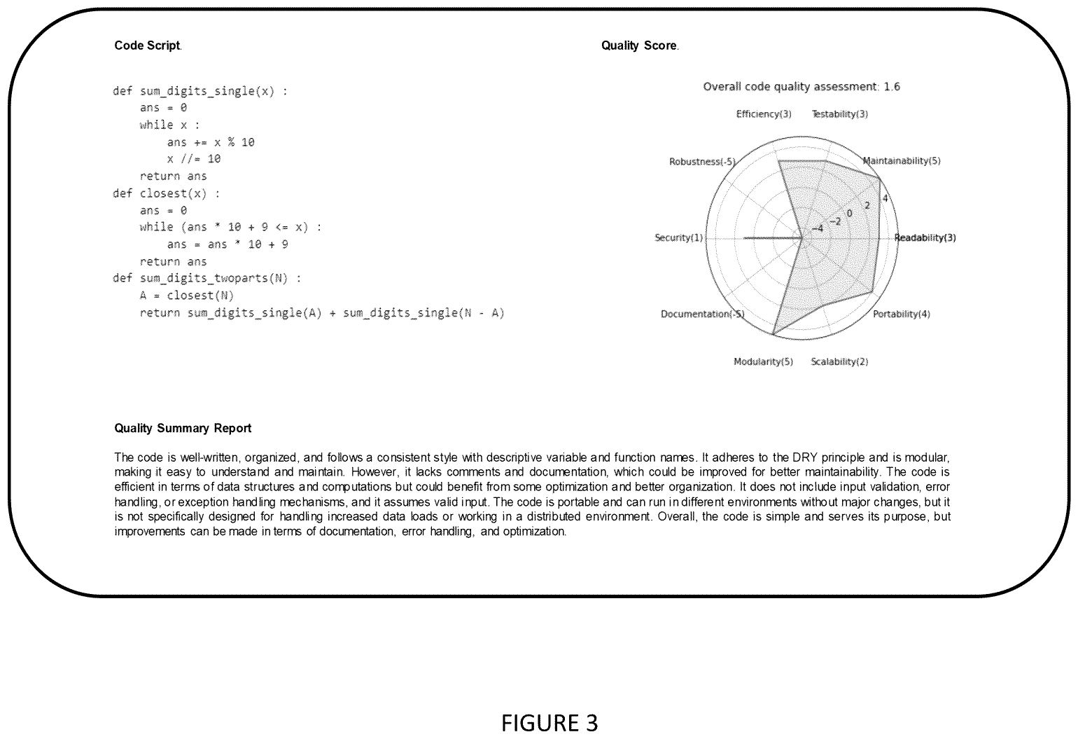

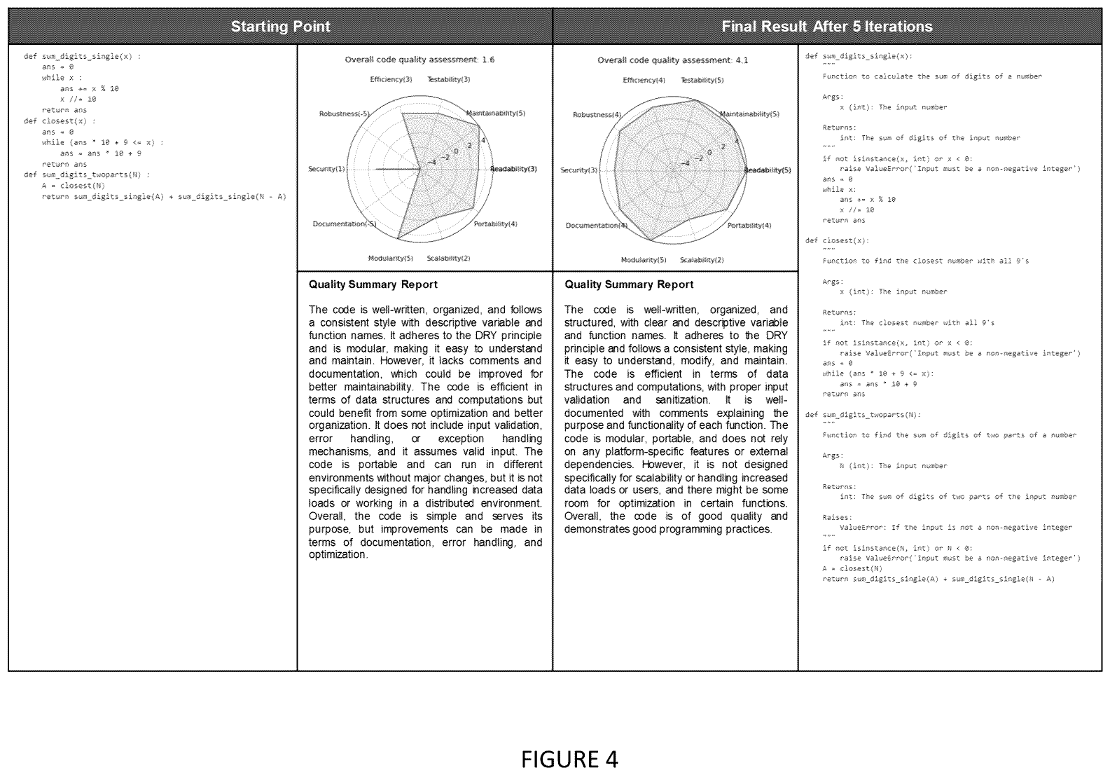

An example of such is provided in FIGS. 3 and 4. FIG. 3 depicts an example of some input code script and the corresponding quality report according to an embodiment. FIG. 3 represents an example of the quality report obtained after any evaluation step, including the last one, meaning that this would also become the final report; the code snippet is just an example of the code being evaluated. FIG. 4 depicts an example of a comparison between some input code script and its initial quality assessment, versus an improved version of the and the final quality assessment report, according to an embodiment.

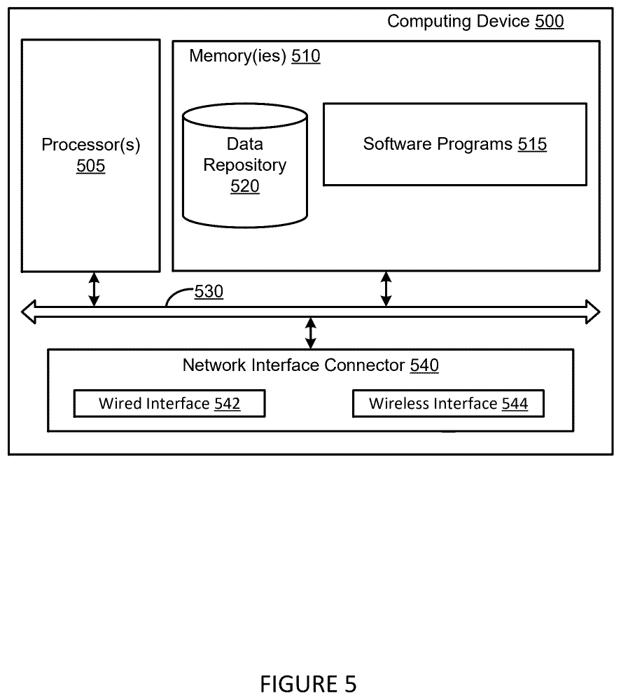

FIG. 5 depicts an exemplary computing system for implementing aspects of the present disclosure. FIG. 5 depicts exemplary computing device 500. Computing device 500 may represent the system components described herein. Computing device 500 may include processor 505 that may be coupled to memory 510. Memory 510 may include volatile memory. Processor 505 may execute computer-executable program code stored in memory 510, such as software programs 515. Software programs 515 may include one or more of the logical steps disclosed herein as a programmatic instruction, which may be executed by processor 505. Memory 510 may also include data repository 520, which may be nonvolatile memory for data persistence. Processor 505 and memory 510 may be coupled by bus 530. Bus 530 may also be coupled to one or more network interface connectors 540, such as wired network interface 542 or wireless network interface 544. Computing device 500 may also have user interface components, such as a screen for displaying graphical user interfaces and receiving input from the user, a mouse, a keyboard and/or other input/output components (not shown).

Although several embodiments have been disclosed, it should be recognized that these embodiments are not exclusive to each other and features from one embodiment may be used with others.

Hereinafter, general aspects of implementation of the systems and methods of embodiments will be described.

Embodiments of the system or portions of the system may be in the form of a “processing machine,” such as a general-purpose computer, for example. As used herein, the term “processing machine” is to be understood to include at least one processor that uses at least one memory. The at least one memory stores a set of instructions. The instructions may be either permanently or temporarily stored in the memory or memories of the processing machine. The processor executes the instructions that are stored in the memory or memories in order to process data. The set of instructions may include various instructions that perform a particular task or tasks, such as those tasks described above. Such a set of instructions for performing a particular task may be characterized as a program, software program, or simply software.

In one embodiment, the processing machine may be a specialized processor.

In one embodiment, the processing machine may be a cloud-based processing machine, a physical processing machine, or combinations thereof.

As noted above, the processing machine executes the instructions that are stored in the memory or memories to process data. This processing of data may be in response to commands by a user or users of the processing machine, in response to previous processing, in response to a request by another processing machine and/or any other input, for example.

As noted above, the processing machine used to implement embodiments may be a general-purpose computer. However, the processing machine described above may also utilize any of a wide variety of other technologies including a special purpose computer, a computer system including, for example, a microcomputer, mini-computer or mainframe, a programmed microprocessor, a micro-controller, a peripheral integrated circuit element, a CSIC (Customer Specific Integrated Circuit) or ASIC (Application Specific Integrated Circuit) or other integrated circuit, a logic circuit, a digital signal processor, a programmable logic device such as a FPGA (Field-Programmable Gate Array), PLD (Programmable Logic Device), PLA (Programmable Logic Array), or PAL (Programmable Array Logic), or any other device or arrangement of devices that is capable of implementing the steps of the processes disclosed herein.

The processing machine used to implement embodiments may utilize a suitable operating system.

It is appreciated that in order to practice the method of the embodiments as described above, it is not necessary that the processors and/or the memories of the processing machine be physically located in the same geographical place. That is, each of the processors and the memories used by the processing machine may be located in geographically distinct locations and connected so as to communicate in any suitable manner. Additionally, it is appreciated that each of the processor and/or the memory may be composed of different physical pieces of equipment. Accordingly, it is not necessary that the processor be one single piece of equipment in one location and that the memory be another single piece of equipment in another location. That is, it is contemplated that the processor may be two pieces of equipment in two different physical locations. The two distinct pieces of equipment may be connected in any suitable manner. Additionally, the memory may include two or more portions of memory in two or more physical locations.

To explain further, processing, as described above, is performed by various components and various memories. However, it is appreciated that the processing performed by two distinct components as described above, in accordance with a further embodiment, may be performed by a single component. Further, the processing performed by one distinct component as described above may be performed by two distinct components.

In a similar manner, the memory storage performed by two distinct memory portions as described above, in accordance with a further embodiment, may be performed by a single memory portion. Further, the memory storage performed by one distinct memory portion as described above may be performed by two memory portions.

Further, various technologies may be used to provide communication between the various processors and/or memories, as well as to allow the processors and/or the memories to communicate with any other entity; i.e., so as to obtain further instructions or to access and use remote memory stores, for example. Such technologies used to provide such communication might include a network, the Internet, Intranet, Extranet, a LAN, an Ethernet, wireless communication via cell tower or satellite, or any client server system that provides communication, for example. Such communications technologies may use any suitable protocol such as TCP/IP, UDP, or OSI, for example.

As described above, a set of instructions may be used in the processing of embodiments. The set of instructions may be in the form of a program or software. The software may be in the form of system software or application software, for example. The software might also be in the form of a collection of separate programs, a program module within a larger program, or a portion of a program module, for example. The software used might also include modular programming in the form of object-oriented programming. The software tells the processing machine what to do with the data being processed.

Further, it is appreciated that the instructions or set of instructions used in the implementation and operation of embodiments may be in a suitable form such that the processing machine may read the instructions. For example, the instructions that form a program may be in the form of a suitable programming language, which is converted to machine language or object code to allow the processor or processors to read the instructions. That is, written lines of programming code or source code, in a particular programming language, are converted to machine language using a compiler, assembler or interpreter. The machine language is binary coded machine instructions that are specific to a particular type of processing machine, i.e., to a particular type of computer, for example. The computer understands the machine language.

Any suitable programming language may be used in accordance with the various embodiments. Also, the instructions and/or data used in the practice of embodiments may utilize any compression or encryption technique or algorithm, as may be desired. An encryption module might be used to encrypt data. Further, files or other data may be decrypted using a suitable decryption module, for example.

As described above, the embodiments may illustratively be embodied in the form of a processing machine, including a computer or computer system, for example, that includes at least one memory. It is to be appreciated that the set of instructions, i.e., the software for example, that enables the computer operating system to perform the operations described above may be contained on any of a wide variety of media or medium, as desired. Further, the data that is processed by the set of instructions might also be contained on any of a wide variety of media or medium. That is, the particular medium, i.e., the memory in the processing machine, utilized to hold the set of instructions and/or the data used in embodiments may take on any of a variety of physical forms or transmissions, for example. Illustratively, the medium may be in the form of a compact disc, a DVD, an integrated circuit, a hard disk, a floppy disk, an optical disc, a magnetic tape, a RAM, a ROM, a PROM, an EPROM, a wire, a cable, a fiber, a communications channel, a satellite transmission, a memory card, a SIM card, or other remote transmission, as well as any other medium or source of data that may be read by the processors.

Further, the memory or memories used in the processing machine that implements embodiments may be in any of a wide variety of forms to allow the memory to hold instructions, data, or other information, as is desired. Thus, the memory might be in the form of a database to hold data. The database might use any desired arrangement of files such as a flat file arrangement or a relational database arrangement, for example.

In the systems and methods, a variety of “user interfaces” may be utilized to allow a user to interface with the processing machine or machines that are used to implement embodiments. As used herein, a user interface includes any hardware, software, or combination of hardware and software used by the processing machine that allows a user to interact with the processing machine. A user interface may be in the form of a dialogue screen for example. A user interface may also include any of a mouse, touch screen, keyboard, keypad, voice reader, voice recognizer, dialogue screen, menu box, list, checkbox, toggle switch, a pushbutton or any other device that allows a user to receive information regarding the operation of the processing machine as it processes a set of instructions and/or provides the processing machine with information. Accordingly, the user interface is any device that provides communication between a user and a processing machine. The information provided by the user to the processing machine through the user interface may be in the form of a command, a selection of data, or some other input, for example.

As discussed above, a user interface is utilized by the processing machine that performs a set of instructions such that the processing machine processes data for a user. The user interface is typically used by the processing machine for interacting with a user either to convey information or receive information from the user. However, it should be appreciated that in accordance with some embodiments of the system and method, it is not necessary that a human user actually interact with a user interface used by the processing machine. Rather, it is also contemplated that the user interface might interact, i.e., convey and receive information, with another processing machine, rather than a human user. Accordingly, the other processing machine might be characterized as a user. Further, it is contemplated that a user interface utilized in the system and method may interact partially with another processing machine or processing machines, while also interacting partially with a human user.

It will be readily understood by those persons skilled in the art that embodiments are susceptible to broad utility and application. Many embodiments and adaptations of the present invention other than those herein described, as well as many variations, modifications and equivalent arrangements, will be apparent from or reasonably suggested by the foregoing description thereof, without departing from the substance or scope.

Accordingly, while the embodiments of the present invention have been described here in detail in relation to its exemplary embodiments, it is to be understood that this disclosure is only illustrative and exemplary of the present invention and is made to provide an enabling disclosure of the invention. Accordingly, the foregoing disclosure is not intended to be construed or to limit the present invention or otherwise to exclude any other such embodiments, adaptations, variations, modifications or equivalent arrangements.

What is claimed is:

1. A method, comprising:
receiving, by a code optimization computer program executed by an electronic device, code to optimize;
evaluating, by the code optimization computer program, the code for a plurality of code quality dimensions using a large language model (LLM), wherein the LLM returns a code quality score and a qualitative summary for each code quality dimension;
generating, by the code optimization computer program, an overall code quality score based on the code quality score and the qualitative summary;
improving, by the code optimization computer program, the code using the LLM based on the code quality score and the qualitative summary for each code quality dimension;
evaluating, by the code optimization computer program, the improved code for the plurality of code quality dimensions using the wherein the LLM returns an updated code quality score and an updated qualitative summary;
generating, by the code optimization computer program, an overall code quality score based on the updated code quality score and the updated qualitative summary; and
outputting, by the code optimization computer program, the improved code in response to the updated code quality score being higher than the overall code quality score.

2. The method of claim 1, wherein the code quality dimensions comprise readability, maintainability, testability, efficiency, robustness, security, documentation, modularity, scalability, and/or portability.

3. The method of claim 1, wherein the code optimization computer program prompts the LLM with code quality dimension-related questions/statements.

4. The method of claim 3, wherein the LLM responds to the code quality dimension-related questions/statements with true, false, or not applicable or values representing the same.

5. The method of claim 3, wherein the LLM is provided with an equal number of quality dimension-related questions/statements for each code quality dimension.

6. The method of claim 5, wherein the overall code quality score for each code quality dimension is an average of the code quality score for each quality dimension-related question/statement from the LLM.

7. The method of claim 1, wherein the LLM returns improvement points, an explanation report, and the improved code in response to a prompt from the code optimization computer program to improve the code.

8. The method of claim 1, further comprising:
validating, by the code optimization computer program, that the improved code exhibits its original intended functionality and/or expected behavior.

9. The method of claim 1, wherein the steps of evaluating the improved code and generating the overall code quality score based on the updated code quality score and the updated qualitative summary are repeated for a number of iterations.

10. The method of claim 1, further comprising:
outputting, by the code optimization computer program, the code quality score, the qualitative summary, the updated code quality score, and the updated qualitative summary for each code quality dimension.

11. A non-transitory computer readable storage medium, including instructions stored thereon, which when read and executed by one or more computer processors, cause the one or more computer processors to perform steps comprising:
receiving code to optimize;
evaluating the code for a plurality of code quality dimensions using a large language model (LLM), wherein the LLM returns a code quality score and a qualitative summary for each code quality dimension;
generating an overall code quality score based on the code quality score and the qualitative summary;
improving the code using the LLM based on the code quality score and the qualitative summary for each code quality dimension;
evaluating the improved code for the plurality of code quality dimensions wherein the LLM returns an updated code quality score and an updated qualitative summary;
generating an overall code quality score based on the updated code quality score and the updated qualitative summary; and
outputting the improved code in response to the updated code quality score being higher than the overall code quality score.

12. The non-transitory computer readable storage medium of claim 11, wherein the code quality dimensions comprise readability, maintainability, testability, efficiency, robustness, security, documentation, modularity, scalability, and/or portability.

13. The non-transitory computer readable storage medium of claim 11, wherein the LLM is prompted with code quality dimension-related questions/statements.

14. The non-transitory computer readable storage medium of claim 13, wherein the LLM responds to the code quality dimension-related questions/statements with true, false, or not applicable or values representing the same.

15. The non-transitory computer readable storage medium of claim 13, wherein the LLM is provided with an equal number of quality dimension-related questions/statements for each code quality dimension.

16. The non-transitory computer readable storage medium of claim 15, wherein the overall code quality score for each code quality dimension is an average of the code quality score for each quality dimension-related question/statement from the LLM.

17. The non-transitory computer readable storage medium of claim 11, wherein the LLM returns improvement points, an explanation report, and the improved code in response to a prompt to improve the code.

18. The non-transitory computer readable storage medium of claim 11, further including instructions stored thereon, which when read and executed by the one or more computer processors, cause the one or more computer processors to perform steps comprising:
validating that the improved code exhibits its original intended functionality and/or expected behavior.

19. The non-transitory computer readable storage medium of claim 11, wherein the steps of evaluating the improved code and generating the overall code quality score based on the updated code quality score and the updated qualitative summary are repeated for a number of iterations.

20. The non-transitory computer readable storage medium of claim 11, further including instructions stored thereon, which when read and executed by the one or more computer processors, cause the one or more computer processors to perform steps comprising:
outputting the code quality score, the qualitative summary, the updated code quality score, and the updated qualitative summary for each code quality dimension.
